(19) United States
(12) Patent Application Publication
(10) Pub. No.: US 2009/0228885 A1
(43) Pub. Date: Sep. 10, 2009

(54) SYSTEM AND METHOD FOR USING WORKFLOWS WITH INFORMATION CARDS

(75) Inventors: Duane F. Buss, West Mountain, UT (US); Thomas E. Doman, Pleasant Grove, UT (US); Andrew A. Hodgkinson, Pleasant Grove, UT (US); Daniel S. Sanders, Orem, UT (US); James G. Sermersheim, Woodland Hills, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/044,816

(22) Filed: Mar. 7, 2008

(51) Int. Cl. G06F 9/46

(52) U.S. Cl. 718/100

(57) ABSTRACT

A system and method for managing information cards using workflows is provided. A workflow manager in a card selector allows the user to initiate cardflows in the card selector. The workflow manager is extensible and programmable so that additional user-defined or industry-defined cardflows can be added to the workflow manager.

### RELATED APPLICATION DATA

This application is related to U.S. application Ser. Nos. 11/843,572; 11/843,638; 11/843,640; 11/843,608 and 11/843,591, all of which were filed Aug. 22, 2007 and claimed the benefit of U.S. application Ser. Nos. 60/895,312; 60/895,316; 60/895,325, all of which were filed Mar. 16, 2007; and is related to U.S. application Ser. No. 12/019,104, filed Jan. 24, 2008, which claimed the benefit of U.S. application Ser. No. 60/973,679 filed Sep. 19, 2007. All of the foregoing applications are herein incorporated by reference.

### FIELD OF THE INVENTION

This invention pertains to information cards, and more particularly to life cycle management of information cards using workflows.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal for the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past year or two, the industry has developed the concept of information cards to attempt to address these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: 1) personal cards (or self-issued cards), and 2) managed cards—or cards that are issued by an identity provider. A personal card contains self-asserted identity information—the person issues the card and is the authority for the identity information it contains. The managed card is issued by an identity provider. The identity provider provides the identity information and asserts its validity.

When a user wants to release identity information to a relying party (for example, a web site that the user is interacting with), a tool known as a card selector assists the user in selecting an appropriate information card. When a managed card is selected, the card selector communicates with the identity provider to obtain a security token that contains the needed information. This interaction between the card selector and the identity provider is usually secure. The identity provider typically requests the user to authenticate himself or herself (for example, using a username/password, X.509 certificate, etc.) before it will return a security token. The identity information can then be provided to the relying party.

As part of the information card system the identity provider can create information cards which are then stored by the card selector. Thereby users can manage their digital identities from various identity providers, as well as selectively examine, manipulate and employ the identities with various online services. The information card is a representation of data that can be included in a security token, with associated claims issuer, authentication requirements, policies, and metadata.

A credit card is a useful analogy that illustrates a problem with conventional information card systems. When an individual is sent a credit card in the mail, the individual may need to call the credit card issuer and provide additional personal information to verify that the individual is authorized to enable the use of the card. The credit card issuer verifies the information to alleviate problems caused by third party interception of the physical card and resulting misuse of the credit card. The credit card issuer can also use the verification process to verify that the new card has been received so that other old cards issued to that account can be deactivated. While information cards can be subject to similar steps, according to conventional methods, a user would have to carry out such processes manually. This can be cumbersome and awkward for the user, especially when the user has many managed cards.

A need remains for a way to address these and other problems associated with the prior art.

### SUMMARY OF THE INVENTION

Embodiments of the invention enable the use of information cards with workflows. A workflow manager in a card selector allows the user to initiate cardflows. The workflow manager is extensible and programmable so that additional user-defined or industry-defined cardflows can be added to the workflow manger. Cardflows can replace many tedious and/or awkward tasks that would conventionally have to be performed manually by the user.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows details of a client according to embodiments of the invention.

FIG. 3 shows a sequence of communications between a client and an identity provider to obtain and activate a managed card according to an embodiment of the invention.

FIG. 4 shows a sequence of communications between a client, a relying party, and an identity provider according to an embodiment of the invention.

FIG. 5 shows a flowchart of a procedure to obtain and activate a managed card according to an embodiment of the invention.

FIG. 6 shows a flowchart of a procedure to invoke a cardflow according to an embodiment of the invention.

### DETAILED DESCRIPTION OF THE PREFERRED EMBODIMENT

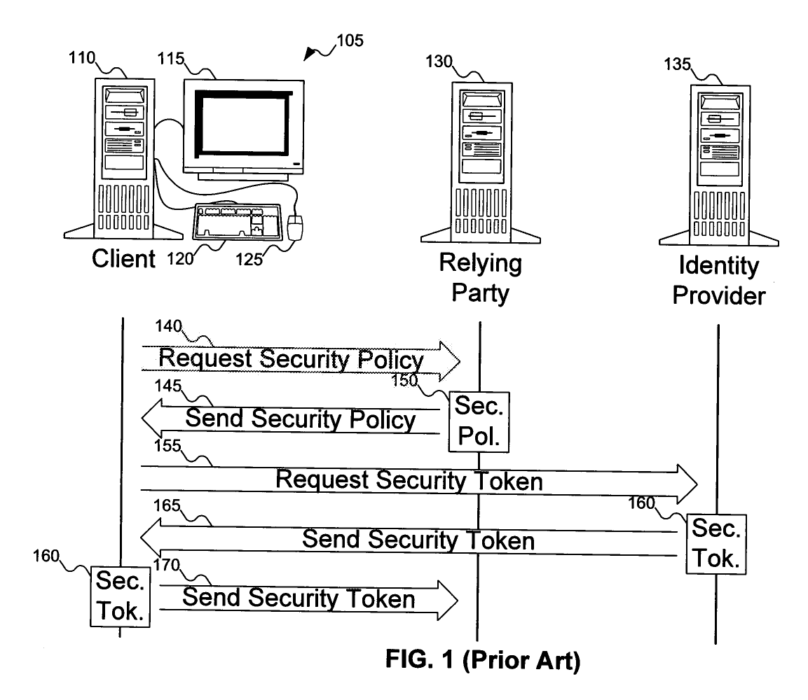

Embodiments of the invention provide workflows for information cards. Consequently, before explaining the invention, it is important to understand the operation of an information card system. Such a system will be explained with respect to FIG. 1.

FIG. 1 shows a sequence of communications between a client, a relying party, and an identity provider. For simplicity, each party (the client, the relying party, and the identity provider) can be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of client 105; for example, a central processing unit, memory, storage, etc. Although not shown in FIG. 1, a person skilled in the art will recognize that client 105 can interact with other computer systems, such as relying party 130 and identity provider 135, either directly or over a network (not shown) of any type. Finally, although FIG. 1 shows client 105 as a conventional desktop computer, a person skilled in the art will recognize that client 105 can be any type of machine or computing device capable of providing the services attributed herein to client 105, including, for example, a laptop computer, a personal digital assistant (PDA), or a cellular telephone.

Relying party 130 is a machine managed by a party that relies in some way on the identity of the user of client 105. The operator of relying party 130 can be any type of relying party. For example, the operator of relying party 130 can be a merchant running a business on a website. Alternatively, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party 130. Depending on the type of information identity provider 135 stores for a user, a single user might store identifying information with a number of different identity providers 135, any of which might be able to satisfy the request of the relying party 130. For example, identity provider 135 might be a governmental agency, responsible for storing information generated by the government, such as a driver's license number or a social security number. Alternatively, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from relying party 130, client 105 requests the security policy of relying party 130, as shown in communication 140, which is returned in communication 145 as security policy 150. Security policy 150 is a summary of the information relying party 130 needs, how the information should be formatted, and so on.

Once client 105 has security policy 150, client 105 can identify which information cards will satisfy security policy 150. Different security policies might result in different information cards being usable. For example, if relying party 130 simply needs a username and password combination, the information cards that will satisfy this security policy will be different from the information cards that satisfy a security policy requesting the user's full name, mailing address, and social security number. The user can then select an information card that satisfies security policy 150.

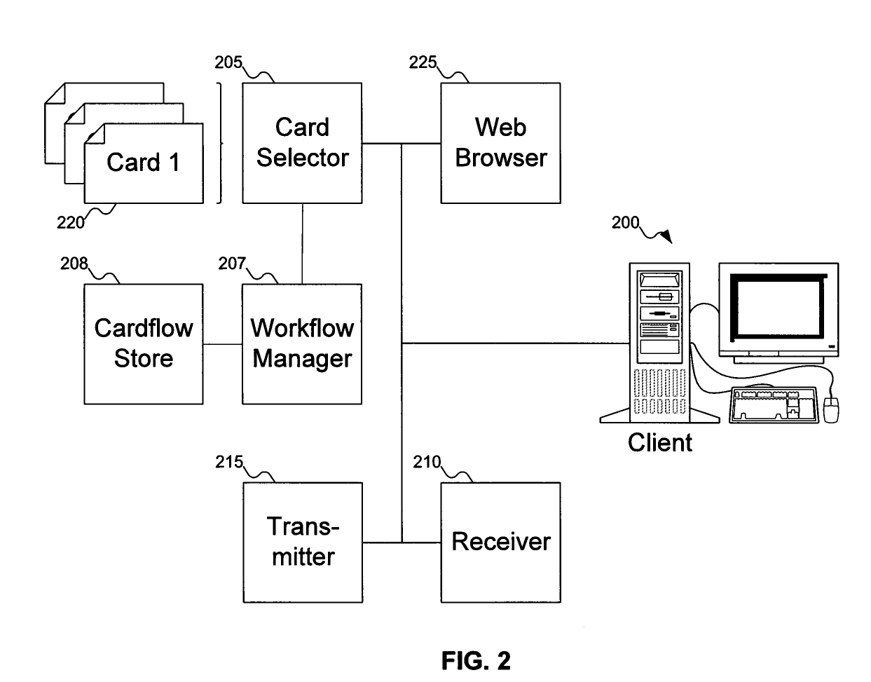

A card selector (described below with respect to FIG. 2) on client 105 can be used by the user to select the information card. The card selector can present the user with a list or graphical display of all available information cards and information cards that satisfy the security policy can be highlighted in some way to distinguish them from the remaining cards. Alternatively, the card selector can display only the information cards that will satisfy the security policy. The card selector can provide a means for the user to select the desired information card by, for instance, a mouse click or a touch on a touch screen.

Once the user has selected an acceptable information card, client 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 can be encrypted in some manner, and perhaps signed and/or time-stamped by identity provider 135, so that relying party 130 can be certain that the security token originated with identity provider 135 (as opposed to being spoofed by someone intent on defrauding relying party 130). Client 105 then forwards security token 160 to relying party 130, as shown in communication 170.

In addition, the selected information card can be a self-issued information card (also called a personal card): that is, an information card issued not by an identity provider, but by client 105 itself. In that case, identity provider 135 effectively becomes part of client 105.

Often, the identity provider 135 takes the form of a web server, but this does not have to be the case. As an example, the identity provider 135 could be a Security Token Service (STS) that resides on the client 105, resides on the network, or even resides on a flash drive.

In the information card system, there are many well-defined operations and interactions between the card selector, the relying party and the identity provider. Further, there are some best practices for how each entity should behave and operate with respect to the other components. However, there are currently no tools to assist the user in information card life cycle management. As an example of an information card life cycle: an information card can be created when it is issued by an identity provider and activated by a card selector; the information card can be updated and modified over time, including being moved to different card stores; and the information card can become expired due to some changed circumstance at either the identity provider or the card selector. No tools currently exist for the user to easily manage these and other aspects of an information card throughout its life cycle.

According to an embodiment of the invention, a card selector includes a workflow manager. The workflow manager allows the user to execute various workflows associated with information cards rather than having to perform individual functions manually.

FIG. 2 shows details of a client according to embodiments of the invention. Referring to FIG. 2, client 200 includes card selector 205, receiver 210, transmitter 215, and browser 225. Card selector 205 enables a user to select an information card 220 that satisfies a security policy, as described above with respect to FIG. 1. Card selector 205 also enables a user to obtain managed cards from identity providers and to install the managed cards on client 200. Receiver 210 receives data transmitted to client 200, and transmitter 215 transmits information from client 200. The receiver 210 and the transmitter 215 can facilitate communications between client 200 and, for example, relying party 130, and identity provider 135. The browser 225 allows the user to interact with web pages on a network: for example, web pages created by the identity provider 135 or the relying party 130.

Card selector 205 includes workflow manager 207. Workflow manager 207 allows the user to execute various workflows on the information cards stored in the card selector 205. Workflow manager 207 also allows various workflows to be associated with specific information cards stored in the card selector 205. Workflows involving information cards can be referred to as cardflows. For example, cardflows can comprise a series of functions to be performed by the card selector 205 in conjunction with a user, relying parties, identity providers, and/or other entities. A single cardflow can also comprise a series of sub-cardflows with the output of individual sub-cardflows being provided as inputs into the next sub-cardflow in the series. Further, a cardflow can comprise a series of sub-cardflows such that the cardflow executes one sub-cardflow and then, based on the output of the sub-cardflow, determines which sub-cardflow to execute next. By using cardflows, the user can initiate the performance of multiple functions without having to manually execute each step. Further, when cardflows are associated with a particular information card, by an identity provider for example, the user can be prompted by the card selector to execute the cardflow. The card selector 205 can prompt the user with, for example, visual and/or non-visual cues. Visual and non-visual cues are described in U.S. patent application Ser. No. 12/029,373, titled VISUAL AND NON-VISUAL CUES FOR CONVEYING STATE OF INFORMATION CARDS, ELECTRONIC WALLETS, AND KEYRINGS, filed 11 Feb. 2008, which is hereby incorporated by reference in its entirety. Also, the card selector 205 can initiate the cardflows without prompting the user. In this case, the card selector 205 may be prompted to initiate the cardflows by occurrences such as receipt of a managed card from an identity provider, receipt of a security token from an identity provider, or receipt of a cardflow identifier from an identity provider.

The workflow manager 207 can include a cardflow store 208. The cardflow store can be used to store various cardflows. The cardflows stored in the cardflow store 208 can be user-defined cardflows and they can be industry-defined cardflows. Also, the cardflows stored in the cardflow store 208 can be provided with the initial installation of the card selector and/or workflow manager and the cardflows can be downloaded from relying parties, identity providers, or some other source after the initial installation of the card selector and/or workflow manager.

Various exemplary uses of cardflows will now be described. However, a person of ordinary skill in the art will recognize that the invention is not limited to these particular uses of cardflows or these particular cardflows.

A user desires to obtain a managed card, and so the user interacts with an identity provider to have the managed card issued. The issued card contains metadata that specifies that it requires activation. For example, the metadata can include a flag that the card selector can use to determine if activation is required. In other words, the user obtains the managed card, but the managed card is not usable until it has been activated. A cue associated with the issued card can be provided in the card selector when the issued card is installed, so that the user knows that activation should be completed before the card can be used to issue a security token. According to conventional methods, the user would have to activate the issued card manually. However, using cardflows, the card selector can be used to execute an activation policy defined by the identity provider. Specifically, the card selector can carry out each of the functions necessary to activate the card without the user having to perform each function manually. These functions can be specified by a cardflow. The workflow manager can determine which functions are appropriate in order for the cardflow to be executed and then direct the card selector to perform these functions. The workflow manager can use a cardflow stored in the cardflow store to determine the appropriate functions. The metadata in the issued card can include information to help the workflow manager determine the appropriate cardflow in the cardflow store. Alternatively, the metadata in the managed card may include the cardflow itself, which the workflow manager can use to determine which functions are appropriate in order for the cardflow to be executed. Therefore, the user does not have to perform the activation manually.

From time to time, a user might desire to export a managed card from one card store and import it into another card store. The user might want to prevent the card from being used by a third party during the transfer of the managed card. Consequently, the user might want to disable the card at the identity provider, export the card from the first card store, import the card into the second card store, activate the card in the second card store, and then enable the card at the identity provider if both the importation and reactivation were successful. Once again, the user has to perform all of these functions manually when using a conventional system. However, using cardflows, the workflow manager can interact with the card selector to execute each of these functions so that the user only has to indicate in the card selector a desire to move the managed card.

On occasion, a user might desire to terminate the use or potential use of a particular managed card. The particular managed card can be associated with a credit card provider, for example. The user wants to be able to “shred” the card in one of several ways. For instance: the user might want the card to be unusable; the user might want the account or persona represented by the card to be disabled; and/or the user might want all accounts or personas registered in the same way to be disabled. Instead of carrying out all the necessary functions manually, the user instead uses the card selector and workflow manager to initiate a cardflow or cardflows to perform these functions. The workflow manager can determine what functions are appropriate to “shred” the managed card(s) and direct the card selector to perform these functions. Then, the card selector can interact with the identity provider to execute the appropriate functions. By use of cardflows, the user can also receive notification that the card was successfully “shredded”, perhaps as a visual and/or non-visual cue.

A user suspects or discovers that fraud has been perpetrated on one of the user's accounts represented by an information card or set of information cards. The fraud might have taken place through some leak of sensitive information (for example, birth day, mother's maiden name, social security number, etc.). The user wants to perform a similar cardflow to that of the paragraph above but in this scenario, the user might want to perform any number of actions on a set of cards, such as: enable fraud protection; “shred” the cards as in the paragraph above; enable heightened auditing or usage alerts; establish new accounts andor account numbers; and/or set in motion alternative verification methods for new credential information, such as traditional mail. Using conventional methods, a user could spend hours or days performing all of these functions. However, using cardflows, the user can simply indicate in the card selector a desire to perform these functions and the card selector can interact with the workflow manager and the appropriate identity provider(s) to carry out these functions.

In some cases, an account with shared information, such as a family account, can be accessed by multiple family members. The account might be compromised by some members of the family, perhaps due to changed circumstances in the family, such as a divorce. Rather than disable the entire account, a user might desire to just revoke the credentials/cards assigned to certain members of the family. According to conventional methods, this could be a very complicated and awkward process for a novice information card user. However, using cardflows, the process can be carried out by the card selector and workflow manager, interacting with the identity provider(s).

An identity provider may desire to revoke or expire an information card or set of information cards. The identity provider can communicate this information when the card is used, perhaps causing a visual cue to be displayed in the card selector. When the identity provider sends back the response to a request for a security token, the response can include a cardflow identifier and/or a cardflow. If the cardflow is invoked it would be possible to trigger actions such as shredding the information card or changing the information card to a disabled state pending further remediation by the user. The user can invoke the cardflow responsive to the visual cue or the cardflow can be initiated automatically upon receipt by the card selector of the response to the request for a security token.

In the example described in the previous paragraph, the identity provider may want to revoke or expire the information card(s) because the account has been disabled due to loss of employment, violation of terms of use, or even death. However, before the card selector has been notified of this account action, the user may attempt to use the information card. When the user attempts to use the information card and a request for a security token is sent, the response from the identity provider can include an identifier for a cardflow to assist the user in managing the temporarily or permanently disabled account. Also, the response could include the cardflow itself, to account for the possibility that the workflow manager does not already have the appropriate cardflow in the cardflow store.

The previous two examples are illustrations of a potential problem with the conventional information card system: the possibility of “zombie cards”. Zombie cards are information cards that are no longer useable for some reason, but either the card selector or the identity provider does not know that the cards are no longer useable. In other words, the cards are “dead”, but they do not “know” it. This situation can arise, for example, if an identity provider has expired an information card but has not notified the user or card selector. Consequently, the card selector (and probably the user) might believe that the card is still valid. Only when the user attempts to use the card will the user discover that it is no longer valid. As another example, a user can use a particular information card for online purchases and so the information card includes credit card information for the user. At some point, the user closes the credit card account associated with the information card, so the information in the card is no longer valid and the user, knowing this information, does not use the card anymore. This fact might not be reported to the identity provider, which believes the card is still valid and usable.

Cardflows can minimize the occurrence of zombie cards by enabling the communications necessary to apprise all appropriate parties of the status of information cards to be handled by the workflow manager and the card selector, rather than the user having to perform them manually. For example, a user can initiate a cardflow to validate all of the information cards stored in the card selector. This cardflow could interact with all of the appropriate identity provider(s) to ensure that there are no zombie cards stored in the card selector. The workflow manger, after retrieving the cardflow from the cardflow store, can direct the card selector to request a security token from identity providers for each managed card in the card selector and then to remove managed cards for which a valid security token is not received from the identity providers. For a user to do this manually could be a very time-consuming process, but using a cardflow, minimal interaction is required from the user and the process can run behind-the-scenes from the user's perspective.

All of the above examples are common operations that might need to be repeated often on different information cards or multiple cards. There is currently no way for these common operations to be defined in the industry across card selectors or to add or modify the flow of common operations within card selectors without modifying the actual code of the card selectors themselves.

According to embodiments of the invention the workflow manager, in conjunction with the card selector, allows common information card-related activities at the card selector to be viewed as triggers which result in cardflows being invoked. In some cases the cardflows are user-defined and in other cases the cardflows can be industry standard cardflows. It is useful to have industry standard cardflows defined which can then be referred to by specific identifiers. This allows interoperability across many card selectors and identity providers. As an example, using a Personal Identification Number (PIN) to decrypt a card and complete card activation might be defined at an industry level so that identity providers can send a card/card reference to a card selector with the industry-specified cardflow identifier. This enables the client to take control and complete the activation using a cardflow that is already stored in the cardflow store or to obtain the cardflow from an industry-trusted source. A second example would be the identity provider sending revocation information to the card selector to get rid of zombie cards.

Industry-defined cardflows can come pre-delivered with the card selector and/or workflow manager. Such cardflows can also be installed later by, for example, downloading the cardflows. The workflow manager can store cardflows in the cardflow store. The workflow manager can also allow cardflows to be added and updated over time. Because the cardflows are managed and/or delivered separately from the information cards, users are protected from accepting active cardflows or content which is malicious or potentially damaging to the client. Cardflows can be signed and verified by an industry source or some other trusted entity.

By treating many of the actions available in the card selector as scriptable elements of a cardflow, it is possible to deliver extensions to the card selector without modifying the actual code of the card selector. This allows users and identity providers both to define and extend identity provider/card selector interaction and provide additional tools to the user for managing cards throughout the life cycle of the card.

According to embodiments of the invention, the workflow manager 207 can also allow the user to define cardflows. For example, the user can use the workflow manager 207 to record a series of functions, while the user is performing the functions, and then designate those functions as a cardflow that can be stored in the cardflow store and then performed repeatedly, whenever the user desires. Also, the workflow manager 207 can allow the user to enter a series of functions, without actually performing the functions, and then designate the series of functions as a cardflow. It should be noted that the user does not have to interact directly with the workflow manager 207 to define cardflows. The user can interact with the card selector interface and the card selector can interact with the workflow manager to define the cardflows. A person of ordinary skill in the art will appreciate that there are many other possible ways that the workflow manager 207 could allow a user to create cardflows.

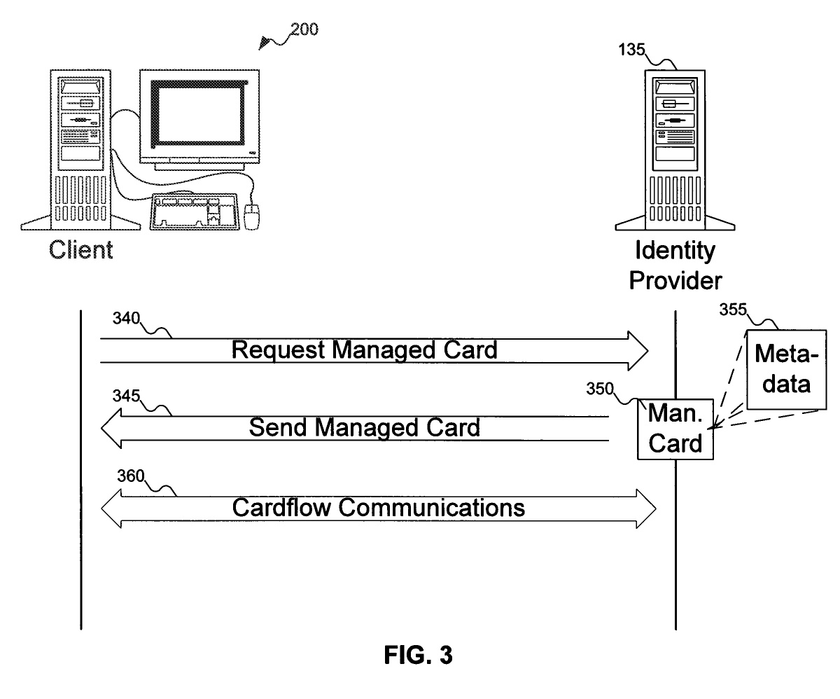

FIG. 3 shows a sequence of communications between a client and an identity provider to obtain and activate a managed card according to an embodiment of the invention. When a user wants to obtain a managed card, the client 200 sends a request 340 for a managed card to the identity provider 135. The request 340 can be sent by the browser 225 on client 200 and can be initiated by, for example, a user selecting a button on a form on a web page created by the identity provider 135. The request 340 can specify that the card selector 205 on client 200 includes workflow manager 207 or supports cardflows, although this is not required.

Once the identity provider 135 receives the request 340 for a managed card, the identity provider 135 examines the request and determines that the client 200 supports cardflows. The identity provider 135 then generates the managed card 350. The managed card 350 can include metadata 355 identifying a cardflow supported by the identity provider 135 to activate the managed card 350. The identity provider 135 can also provide additional cardflow identifiers in metadata 355 that can be used for other purposes: for example, to permit the user to disable or expire the managed card 350. Also, the metadata 355 could include a cardflow itself that describes the actions necessary to activate the managed card 350, to account for the possibility that the client 200 does not have the appropriate cardflow stored in the cardflow store. The managed card 350 is then sent to the client 200 in communication 345. Although in this example, the identity provider 135 determines whether the client 200 supports cardflows, this does not have to be the case. For example, the identity provider 135 can automatically include cardflow metadata with the managed card 350, without first determining whether the client 200 supports cardflows. If the client 200 does not support cardflows, then the client 200 can ignore the metadata 355.

When the client 200 receives the message 345 including the managed card 350, the client 200 invokes the card selector 205 in order to install the managed card 350. During installation of the managed card 350, the card selector 205 can invoke the workflow manager 207 to activate the card. According to some embodiments, the card selector 205 can prompt the user to indicate whether the user wants to activate the card using a cardflow or manually. Alternatively, the card selector 205 can proceed using the cardflow without prompting the user. The workflow manager 207 then determines the functions associated with the cardflow and directs the card selector 205 to carry out these functions. If the metadata 355 includes a cardflow identifier, the workflow manager 207 can determine the appropriate functions by retrieving the cardflow from the cardflow store 208 or by downloading the cardflow from a trusted source. If the metadata 355 includes the cardflow itself, the workflow manager 207 can determine the appropriate functions from the metadata 355. The card selector 205 then initiates a series of communications 360 between the card selector 205 and the identity provider 135 to activate the managed card 350. Once the activation cardflow is complete, the managed card 350 is available for use. It should be noted that activation of the managed card 350 does not necessarily include only communications between the identity provider 135 and the client 200. For example, activation of the managed card 350 could include out-of-band communications, such as a letter sent through traditional mail from the identity provider 135 to the user, or a telephone call between the user and some manual or automatic system of the identity provider 135. Therefore, the activation cardflow could include input from the user.

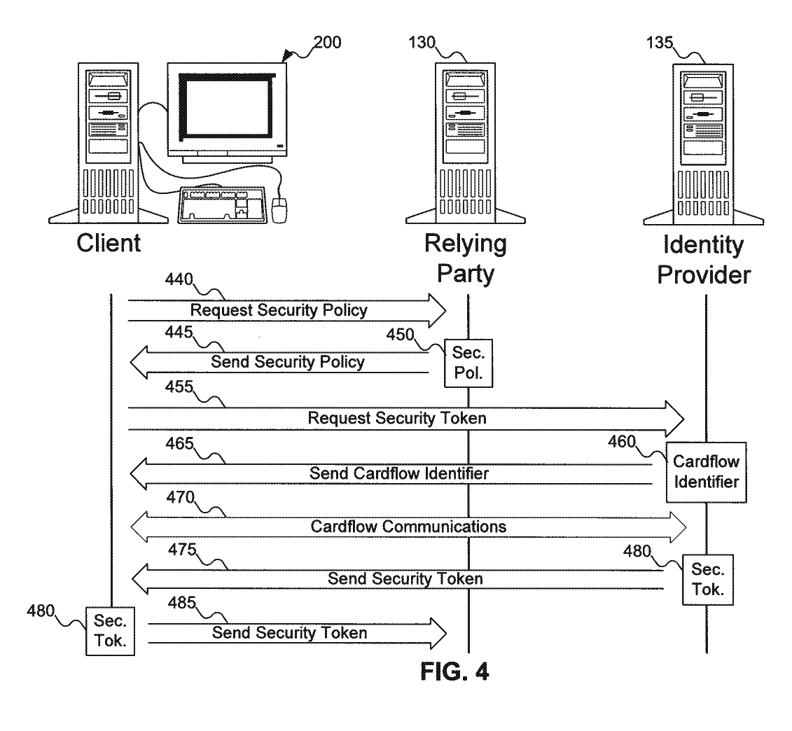

FIG. 4 shows a sequence of communications between a client, a relying party, and an identity provider according to an embodiment of the invention. Referring to FIG. 4, a user wants to access some data or resources from relying party 130, and so client 200 requests the security policy of relying party 130, as shown in communication 440, which is returned in communication 445 as security policy 450. Once client 200 has security policy 450, the card selector 205 can identify which information cards will satisfy security policy 450. The card selector 205 can then present the user with the appropriate information cards and the user can select an information card that satisfies the security policy 450. Once the user has selected an acceptable information card, client 200 uses the selected information card to transmit a request for a security token to identity provider 135, as shown in communication 455.

Unbeknownst to the user, the selected information card is not currently usable. In other words, the identity provider is unwilling to provide a security token associated with the selected information card. This can happen, for example, because the user has not interacted with this identity provider for an extended period of time and so the identity provider wants new credentials for the information card. Consequently, instead of providing a security token, the identity provider 135 returns a cardflow identifier 460 to the client 200 in communication 465. The cardflow identifier 460 indicates a cardflow that needs to be completed before identity provider 135 will issue a security token. The card selector 205 then invokes the workflow manager 207 to determine what functions are necessary to comply with the cardflow identifier 460. The card selector 205 can prompt the user to accept initiation of the cardflow or the card selector 205 can initiate the cardflow without prompting the user. The card selector 205 then interacts with the identity provider 135, and possibly the user, as shown in communications 470. When the cardflow is complete, the identity provider 135 returns security token 480, as shown in communication 475. Client 200 then forwards security token 480 to relying party 130, as shown in communication 485. The relying party 130 can then grant the user access to the desired data or resources. Although in this embodiment the identity provider 135 provides a cardflow identifier 460 to the card selector 205, the identity provider could also provide a cardflow itself, to account for the possibility that the card selector/workflow manager does not have access to the appropriate cardflow by other means (i.e., the appropriate cardflow is not stored in the cardflow store).

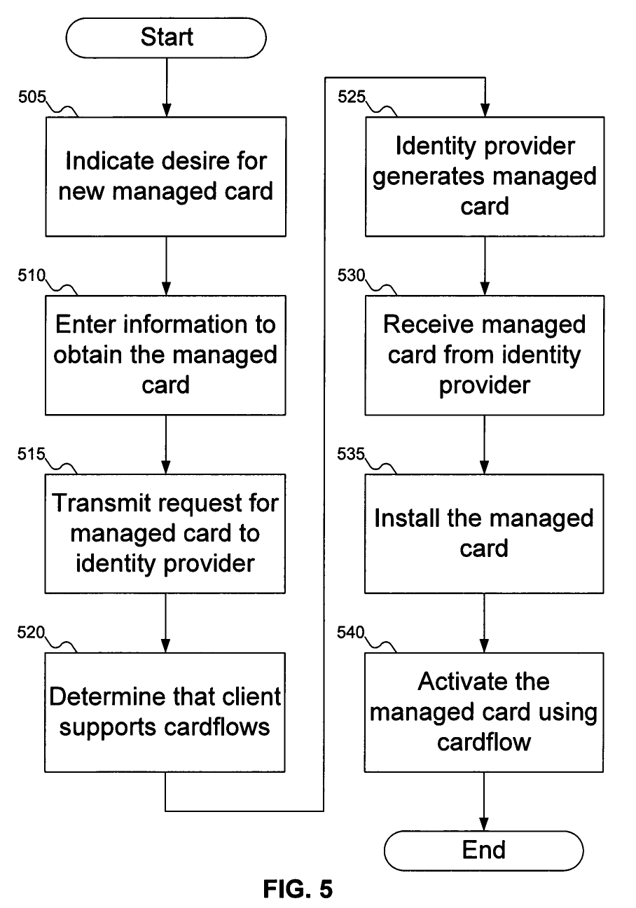

FIG. 5 shows a flowchart of a procedure to obtain and activate a managed card according to an embodiment of the invention. Referring to FIG. 5, at block 505, a user indicates a desire to obtain a new managed card. The user can indicate this desire, for example, by using the browser 225 to visit a web page created by the identity provider 135 and clicking or touching a button in the browser 225. At block 510, the user enters information needed to obtain the managed card. As an example, identity provider 135 can prompt the user for this information by providing a web-based form to the browser 225. A request for the managed card, along with the supporting information provided by the user, is transmitted to the identity provider 135 at block 515. The request for the managed card can indicate that the client 200 supports cardflows.

At block 520, the identity provider 135 analyzes the request for the managed card and determines that the client 200 supports cardflows. The identity provider 135 does not have to determine if the client 200 supports cardflows, however. The identity provider 135 could assume that the client 200 supports cardflows. The identity provider 135 then generates the managed card at block 525. The managed card can have metadata including a cardflow identifier or a cardflow to be used to activate the managed card, among other possible cardflows.

At block 530, the card selector 205 receives the managed card from the identity provider 135. At block 535, the card selector 205 installs the managed card. Installing the managed card can include prompting the user about whether or not to use a cardflow to activate the managed card. Alternatively, the managed card, when installed, can include a visual or non-visual cue indicating that the card needs to be activated before use. If the user chooses to use a cardflow to activate the card, the card selector 205 can invoke the workflow manager 207 to determine the appropriate functions associated with the cardflow. The workflow manager 207 can then direct the card selector 205 to execute the appropriate functions. At block 540, the card selector 205 interacts with the identity provider 135 to activate the managed card. Once the managed card is activated, the card is available for use.

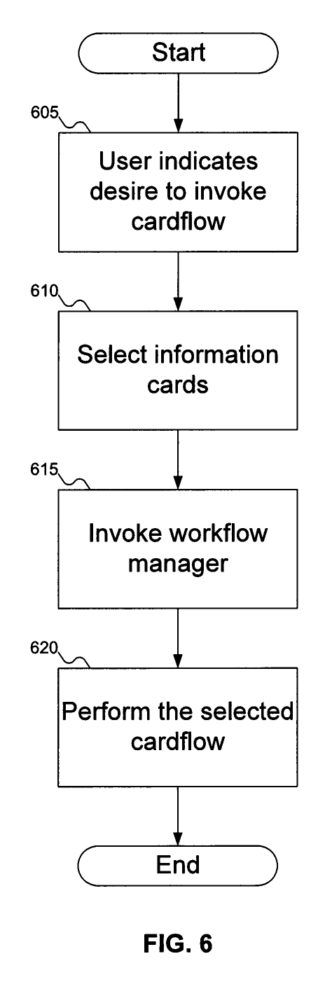

FIG. 6 shows a flowchart of a procedure to invoke a cardflow according to an embodiment of the invention. Referring to FIG. 6, at block 605, the user indicates a desire to invoke a cardflow in the card selector 205. The user can indicate this desire by, for example, selecting a particular cardflow from a list of supported cardflows in the card selector 205. The selected cardflow can be a user-defined cardflow or it can be a cardflow that is industry-defined. At block 610, the user selects one or more information cards that are to be affected by the cardflow. The card selector 205 then invokes the workflow manager 207 to determine the functions required to execute the selected cardflow with the selected information cards at block 615. At block 620, the card selector 205 interacts with an identity provider, or identity providers, and possibly the user, to carry out the selected cardflow.

Although the method of FIG. 6 is described as a user selecting a cardflow and then selecting one or more information cards, the cardflow can be initiated by a user first selecting one or more information cards and then selecting one or more cardflows to carry out on the selected information card(s). As an example, the user could select an information card and then drag-and-drop the information card onto a “Shredder” icon in the card selector, indicating that the user would like to initiate the shred cardflow.

According to some embodiments of the invention, the selected cardflow can be a credential update cardflow that is used to update the credential of one or more information cards with one or more identity providers. Also, the selected cardflow could be directed to any of the other examples described above or any combination of these examples.

As described above, the user can select a single information card or multiple information cards to be affected by the cardflow. However, the user can also choose a category of information cards to be affected by the cardflow. Information card categorization is described in U.S. patent application Ser. No. 11/843,591, filed Aug. 22, 2007 and titled CREDENTIAL CATEGORIZATION, which is hereby incorporated by reference in its entirety. By selecting a category of information cards, the user can execute a particular cardflow on an entire category of information cards without having to individually select the desired cards.

As described above, cardflows can be implemented to carry out many functions associated with information cards that previously had to be done manually. A workflow manager in the card selector can allow various user-defined and industry-defined cardflows to be implemented. Further, as more cardflows are developed, the workflow manager can be updated to include these new cardflows. The workflow manager can allow cardflows to be carried out on single information cards or many information cards. The workflow manager and the card selector can execute cardflows behind the scenes from the user perspective, freeing the user to work on other things.

Although the cardflows described above are carried out between the client and the identity provider, cardflows can also be carried out between the card selector and one or more relying parties, between the card selector and one or more identity providers and one or more relying parties, or simply within the card selector itself. However, from a security standpoint, cardflows involving relying parties can be more suspect than cardflows involving identity providers because the user may not consider relying parties to be trusted sources. Therefore, a user can exercise more discretion in installing and executing cardflows involving relying parties.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. An apparatus, comprising:
a machine;
a receiver on the machine configured to receive communications from at least one identity provider;
a transmitter on the machine configured to send communications to the at least one identity provider;
a card selector on the machine configured to receive a selection of at least one information card from a user; and
a workflow manager on the machine, the workflow manager configured to interact with the card selector to execute a cardflow on the at least one information card; and
a cardflow store configured to store the cardflow.

2. An apparatus according to claim 1, wherein the cardflow store is further configured to store a plurality of user-defined cardflows.

3. An apparatus according to claim 1, wherein the cardflow store is further configured to store a plurality of industry-defined cardflows.

4. An apparatus according to claim 1, wherein the card selector is further configured to interact with at least one of the user, an identity provider, and a relying party to execute the cardflow.

5. An apparatus according to claim 1, wherein the receiver is further configured to receive at least one of a cardflow identifier and the cardflow from the at least one identity provider.

6. An apparatus according to claim 5, wherein the workflow manager is further configured to determine a plurality of functions from the cardflow identifier or the cardflow received from the at least one identity provider.

7. An apparatus according to claim 1, wherein the information card is a zombie card and the cardflow comprises a plurality of functions to remove the zombie card from the card selector.

8. A method, comprising:
receiving a request for a cardflow;
invoking a workflow manager responsive to the request;
identifying a plurality of functions associated with the cardflow; and
performing the functions associated with the cardflow on at least one information card.

9. A method according to claim 8, wherein receiving the request for the cardflow comprises receiving the request from a user.

10. A method according to claim 8, wherein receiving the request for the cardflow comprises receiving at least one of a cardflow identifier and the cardflow from an identity provider.

11. A method according to claim 8, wherein performing the functions associated with the cardflow comprises interacting with one or more of a user, an identity provider, and a relying party to perform the functions associated with the cardflow.

12. A method according to claim 8, wherein receiving the request for the cardflow comprises receiving a request for at least one of an information card credential update, an information card activation, a fraud protection process, an information card shred, and an information card enable/disable process.

13. A method according to claim 8, wherein identifying the plurality of functions associated with the cardflow comprises retrieving the cardflow from a cardflow store.

14. An article, comprising a storage medium, the storage medium having stored thereon instructions that, when executed by a machine, result in:
receiving a request for a cardflow;
invoking a workflow manager responsive to the request;
identifying a plurality of functions associated with the cardflow; and
performing the functions associated with the cardflow on at least one information card.

15. An article according to claim 14, wherein receiving the request for the cardflow comprises receiving the request from a user.

16. An article according to claim 14, wherein the request for the cardflow comprises at least one of a cardflow identifier and the cardflow.

17. An article according to claim 14, wherein performing the functions associated with the cardflow comprises interacting with one or more of a user, an identity provider, and a relying party to perform the functions associated with the cardflow.

18. An article according to claim 14, wherein the request for the cardflow comprises at least one of an information card credential update, an information card activation, a fraud protection process, an information card shred, and an information card enable/disable process.

19. An article according to claim 14, wherein identifying the plurality of functions associated with the cardflow comprises retrieving the cardflow from a cardflow store.

20. A method, comprising:
selecting a cardflow in a card selector;
selecting at least one information card as a target of the cardflow; and
executing the cardflow on the selected information cards.

21. A method according to claim 20, wherein selecting the cardflow and selecting the information card comprises: selecting at least one information card and then selecting a cardflow to execute on the at least one information card.

22. A method according to claim 20, wherein selecting the cardflow includes selecting a cardflow comprising at least one of an information card credential update, an information card activation, a fraud protection process, an information card shred, and an information card enable/disable process.

23. A method according to claim 20, wherein executing the cardflow comprises interacting with at least one of a user, an identity provider, and a relying party.

24. An article, comprising a storage medium, the storage medium having stored thereon instructions that, when executed by a machine, result in:
selecting a cardflow in a card selector;
selecting at least one information card as a target of the cardflow; and
executing the cardflow on the selected information cards.

25. An article according to claim 24, wherein selecting the cardflow and selecting the information card comprises: selecting at least one information card and then selecting a cardflow to execute on the at least one information card.

26. An article according to claim 24, wherein the cardflow comprises at least one of an information card credential update, an information card activation, a fraud protection process, an information card shred, and an information card enable/disable process.

27. An article according to claim 24, wherein executing the cardflow comprises interacting with at least one of a user, an identity provider, and a relying party.
